(19) United States
(12) Patent Application Publication
(10) Pub. No.: US 2026/0161561 A1
(43) Pub. Date: Jun. 11, 2026

(54) STORAGE DEVICE, HOST DEVICE, AND COMPUTING SYSTEM INCLUDING STORAGE DEVICE AND HOST DEVICE, PERFORMING OPERATION ACCORDING TO HASH ALGORITHM

(71) Applicant: SAMSUNG ELECTRONICS CO., LTD., Suwon-si (KR)

(72) Inventors: Wijik LEE, Suwon-si (KR); Donggil Kang, Suwon-si (KR); Jongmin Kim, Suwon-si (KR); Jiyoup Kim, Suwon-si (KR); Dongmin Shin, Suwon-si (KR); Joohyeong Yoon, Suwon-si (KR); Bohwan Jun, Suwon-si (KR)

(73) Assignee: SAMSUNG ELECTRONICS CO., LTD., Suwon-si (KR)

(21) Appl. No.: 19/314,627

(22) Filed: Aug. 29, 2025

(30) Foreign Application Priority Data
Dec. 6, 2024 (KR) 10-2024-0180229

(51) Int. Cl. G06F 12/0802

(52) U.S. Cl. CPC G06F 12/0802; G06F 2212/60

(57) ABSTRACT

Provided is a host device. The host device includes: a cache configured to temporarily store data copied from a main memory; and a processor configured to process the data read from the cache. The cache includes a plurality of ways, wherein each of the plurality of ways has regions distinguished by a plurality of indices, the data include first data, and the plurality of indices include a first index. The processor includes a cache managing circuit configured to: generate the first index by using a first adaptive matrix and a first vector, wherein the first adaptive matrix is based on upper bits of a first address corresponding to the first data, and the first vector is based on lower bits of the first address; and manage the first data to be temporarily stored in an empty region, among regions corresponding to the first index, in the plurality of ways.

### CROSS-REFERENCE TO RELATED APPLICATION

This application claims priority under 35 U.S.C. § 119 to Korean Patent Application No. 10-2024-0180229, filed on Dec. 6, 2024, in the Korean Intellectual Property Office, the disclosure of which is incorporated by reference herein in its entirety.

### BACKGROUND

The present disclosure relates to a storage device and a host device, and more particularly, to a storage device and a host device, which perform operations by using buffer memory or cache.

A device that performs memory operations or performs data processing operations, such as a storage device and a host device, may utilize specific memory, such as buffer memory or cache, to improve operating speeds or performance.

To access the specific memory, the device may generate an index by applying a hash algorithm (or a hash function) to an address received from the outside or generated internally. However, because related hash algorithms are based on a linear method, only certain indices supported by specific memory are intensively used. Accordingly, the utilization efficiency of specific memory may be low, resulting in deteriorated performance of devices.

### SUMMARY

One or more embodiments provide a storage device that efficiently utilizes buffer memory or a host device that efficiently utilizes cache, by generating an index based on a hash algorithm (or hash function) with nonlinear elements added.

According to an aspect of an embodiment, a host device includes: a cache configured to temporarily store a plurality of data copied from a main memory; and a processor configured to process the plurality of data read from the cache. The cache includes a plurality of ways, wherein each of the plurality of ways has regions distinguished by a plurality of indices, the plurality of data include first data, and the plurality of indices include a first index. The processor includes a cache managing circuit configured to: generate the first index by using a first adaptive matrix and a first vector, wherein the first adaptive matrix is based on upper bits of a first address corresponding to the first data, and the first vector is based on lower bits of the first address; and manage the first data to be temporarily stored in an empty region, among regions corresponding to the first index, in the plurality of ways.

According to another aspect of an embodiment, a host device includes: a cache configured to temporarily store a plurality of data copied from main memory; and a processor configured to process the plurality of data read from the cache. The cache includes a plurality of ways, wherein each of the plurality of ways has regions distinguished by a plurality of indices, the plurality of data include first data, and the plurality of indices include a first index. The processor includes a cache managing circuit configured to: generate the first index by performing a hash operation on a first address corresponding to the first data by using a first adaptive matrix based on a first thread corresponding to the first data; and manage the first data to be temporarily stored in an empty region, among regions corresponding to the first index, in the plurality of ways.

According to another aspect of an embodiment, a method of operating a host device is provided. The host device includes a cache. The cache includes a plurality of ways. Each of the plurality of ways has regions distinguished by a plurality of indices. The method includes: generating an adaptive matrix, based on upper bits of an address corresponding to data; generating a vector, based on lower bits of the address; performing a hash operation, based on the adaptive matrix and the vector; and storing the data in an empty region, among regions corresponding to an index generated from the hash operation, in the plurality of ways.

According to another aspect of an embodiment, a storage device includes: a memory device including a non-volatile memory; a memory controller configured to control a first memory operation of the memory device, based on a first address and a first memory command received from an external device; and buffer memory allocated to the memory controller and including a plurality of ways, wherein each of the plurality of ways has regions distinguished by a plurality of indices. The memory controller includes a memory managing circuit configured to: generate a first index, of the plurality of indices, by using a first adaptive matrix and a vector, wherein the first adaptive matrix is based on upper bits of the first address, and the vector is based on lower bits of the first address; and control the first memory operation, based on a state of a region, corresponding to the first index and the first memory command, in the plurality of ways.

### BRIEF DESCRIPTION OF DRAWINGS

The above and other aspects and features will be more apparent from the following description of embodiments, taken in conjunction with the accompanying drawings, in which:

FIG. 1 is a schematic block diagram of a computing system according to an embodiment;

FIG. 2 is a diagram illustrating an operation of a cache managing circuit according to an embodiment;

FIG. 3 is a diagram illustrating an operation method of an index generator according to an embodiment;

FIG. 4 is a diagram specifically illustrating an operation method of an index generator according to an embodiment;

FIG. 5 is a flowchart of an operation method of a host device, according to an embodiment;

FIG. 6A is a diagram illustrating a fixed matrix in an environment where a process is performed by first to third threads, according to a comparative example, and FIG. 6B is a diagram illustrating first to third adaptive matrices in an environment where a process is performed by first to third threads, according to an embodiment;

FIG. 7A is a diagram illustrating an operation of a cache managing circuit in FIG. 6A, and FIG. 7B is a diagram illustrating an operation of a cache managing circuit in FIG. 6B;

FIG. 8 is a diagram illustrating an operation of a cache managing circuit according to an embodiment;

FIGS. 9A, 9B and 9C are flowcharts of a method of generating an adaptive matrix according to an embodiment;

FIG. 10 is a flowchart of a method of updating an adaptive matrix according to an embodiment;

FIG. 11 is a diagram of a host device according to an embodiment;

FIG. 12 is a diagram illustrating an operation of a storage device according to an embodiment;

FIG. 13 is a diagram illustrating an operation of a memory managing circuit according to an embodiment;

FIG. 14 is a diagram illustrating an operation of a memory managing circuit in an environment in which a process is performed by first and second threads, according to an embodiment;

FIG. 15 is a block diagram of a system on chip according to an embodiment; and

FIG. 16 is a block diagram of an electronic device according to an embodiment.

### DETAILED DESCRIPTION

Hereinafter, embodiments are described in detail with reference to the accompanying drawings. Embodiments described herein are example embodiments, and thus, the present disclosure is not limited thereto, and may be realized in various other forms. Each embodiment provided in the following description is not excluded from being associated with one or more features of another example or another embodiment also provided herein or not provided herein but consistent with the present disclosure.

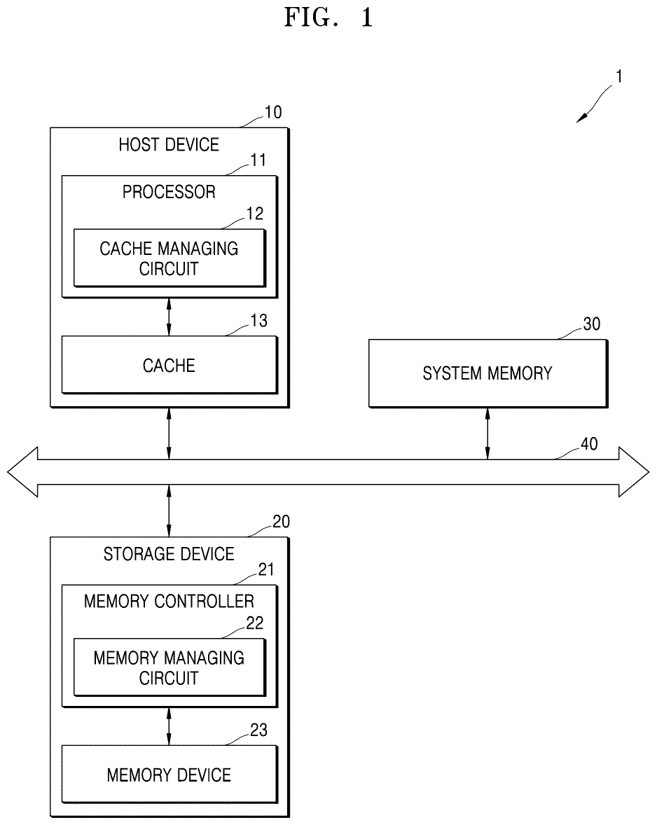

FIG. 1 is a schematic block diagram of a computing system 1 according to an embodiment.

Referring to FIG. 1, the computing system 1 may include a host device 10, a storage device 20, system memory 30, and a bus interface 40.

According to embodiments, the computing system 1 may correspond to any one of a smartphone, a tablet personal computer (PC), a smart TV, a mobile phone, a laptop, a media player, a digital camera, a home appliance, a wearable device, a computing device, and the like. However, these are provided as examples, and embodiments are not limited thereto. The computing system 1 may be implemented as various devices.

According to an embodiment, the host device 10, the storage device 20, and the system memory 30 may communicate with each other through the bus interface 40. As an example, the bus interface 40 may support any one of the following protocols: peripheral component interconnect (PCI), PCI express (PCIe), universal serial bus (USB), serial advanced technology attachment (SATA), and compute express link (CXL).

According to an embodiment, the system memory 30, which is memory allocated to the host device 10, may be used by the processor 11 to store necessary data or processed data when the processor 11 performs data processing operations. In this specification, the system memory 30 may be referred to as main memory. As an example, the system memory 30 may include volatile memory implemented as one of static random-access memory (SRAM) and dynamic random-access memory (DRAM). However, these are provided as examples, and embodiments are not limited thereto. The system memory 30 may include nonvolatile memory implemented as one of phase-change random-access memory (PRAM), magnetic random-access memory (MRAM), and ferroelectric random-access memory (FeRAM).

According to an embodiment, the host device 10 may include a processor 11 and a cache 13. The processor 11 may include a cache managing circuit 12. As an example, the cache managing circuit 12 may be configured to perform necessary operations so that the processor 11 may efficiently use the cache 13, according to embodiments. The cache managing circuit 12 may be implemented in hardware dedicated to performing the operations, or may be implemented by the processor 11 operating according to software instructions. In this specification, the operations of the cache managing circuit 12 may be understood as operations of the host device 10 or the processor 11.

According to an embodiment, the cache 13 may cache data frequently used by the host device 10 from among data stored in the system memory 30. In this specification, caching may be defined as a process of temporarily storing a copy of data stored in particular memory in the cache 13 so that the processor 11 can access the data more quickly. As an example, the cache 13 may include a plurality of ways. The ways of the cache 13 may include regions distinguished by a plurality of indices. A region of the way of the cache 13 may include a memory space where data copied from the system memory 30 is stored and an index indicating the region may correspond to a specific address. As an example, a cache line including a validity bit, a tag, and data may be stored in the region of the way of the cache 13. The validity bit is a bit indicating whether the corresponding cache line is valid and the tag is information indicating a cache address for the corresponding region of the cache 13. The validity bit and the tag may be combined with the index to search for an address of the system memory 30 in which data of the corresponding cache line is stored.

According to an embodiment, to temporarily store the data stored in the system memory 30 frequently used by the processor 11 in the cache 13, the cache managing circuit 12 may generate the index corresponding to the data by using a hash function. As a specific example, the cache managing circuit 12 may input an address for reading data stored in the system memory 30 into the hash function and may use a value output from the hash function as the index. In this specification, an operation using a hash function is performed according to a hash algorithm matching the hash function. The operation may include generating an adaptive matrix to be described below and a vector to be described below, and performing certain operations between the adaptive matrix and the vector. In addition, in this specification, an operation using the hash function may be referred to as a hash operation.

As an example, the cache managing circuit 12 may generate the index corresponding to the data using the adaptive matrix based on upper bits of the address corresponding to the data and the vector based on lower bits of the address corresponding to the data. As another example, the cache managing circuit 12 may generate the index corresponding to the data using the adaptive matrix based on a thread corresponding to the data and the vector based on lower bits of the address. In this specification, the thread is a subject that performs a task of processing data, wherein the processor 11 may perform a process through a plurality of threads.

According to embodiments, to temporarily store data of the system memory 30 in the cache 13, the cache managing circuit 12 may generate the index through a nonlinear operation method by generating the adaptive matrix and the vector based on information on the data and using the generated adaptive matrix and vector for certain operations. Thus, regions corresponding to the plurality of indices of the cache 13 may be evenly used, which allows the cache 13 to be efficiently used. As a result, the performance of the host device 10 may be improved.

According to an embodiment, the storage device 20 may include a memory controller 21 and a memory device 23. The memory controller 21 may include a memory managing circuit 22. As an example, the memory managing circuit 22 is configured to perform necessary operations so that the memory controller 21 may effectively control the memory operation of the memory device 23, according to embodiments. The memory managing circuit 22 may be implemented in hardware dedicated to performing the operations, or may be implemented by the memory controller 21 operating according to software instructions. In this specification, the operations of the memory managing circuit 22 may be understood as operations of the storage device 20 or the memory controller 21.

According to an embodiment, the memory controller 21 may control the memory operations of the memory device 23 based on memory commands received from the host device 10. The memory controller 21 may intensively receive a plurality of memory commands from the plurality of threads of the host device 10. When the memory controller 21 controls the memory operations of the memory device 23 according to the plurality of memory commands, management may be required to prevent conflicts between memory operations. The memory managing circuit 22 may perform operations to prevent conflicts between the memory operations of the memory device 23, where the memory managing circuit 22 may utilize buffer memory of the storage device 20 allocated to the memory controller 21. As an example, the buffer memory may include a plurality of ways. The ways of the buffer memory may include regions distinguished by the plurality of indices. A region of the way of the buffer memory is a memory space where a specific address corresponding to a memory region that is a target of the memory operations frequently performed by the memory device 23 is stored and an index indicating the region may correspond to the specific address. As an example, status information indicating a state of the region may be further stored in the region of the way of the buffer memory. In this specification, the status information may include information indicating a type of the memory operations and whether the memory operations are being performed on the memory region of the memory device 23 corresponding to the region.

According to an embodiment, to temporarily store the address corresponding to the memory region of the memory device 23 for which the memory operations are frequently requested by the host device 10 in the buffer memory, the memory managing circuit 22 may generate, by using the hash function, an index corresponding to the address. As a specific example, the memory managing circuit 22 may input the address received from the host device 10 into the hash function and use a value output from the hash function as the index.

As an example, the memory managing circuit 22 may generate the index corresponding to the address using the adaptive matrix based on upper bits of the address and the vector based on lower bits of the address. As another example, the memory managing circuit 22 may generate an index corresponding to the data using the adaptive matrix based on the thread corresponding to the address and the vector based on lower bits of the address.

According to embodiments, to manage the memory operations by storing frequently used addresses in the buffer memory, the memory managing circuit 22 may generate an index through the nonlinear operation method by generating the adaptive matrix and the vector based on information on the corresponding address and using the generated adaptive matrix and vector for certain operations. Thus, regions corresponding to the plurality of indices of the buffer memory may be evenly used, which allows the buffer memory to be efficiently used. As a result, the performance of the memory controller 21 may be improved.

In FIG. 1, both the cache managing circuit 12 and the memory managing circuit 22 are provided as examples. The computing system 1 may include only one of the cache managing circuit 12 and the memory managing circuit 22.

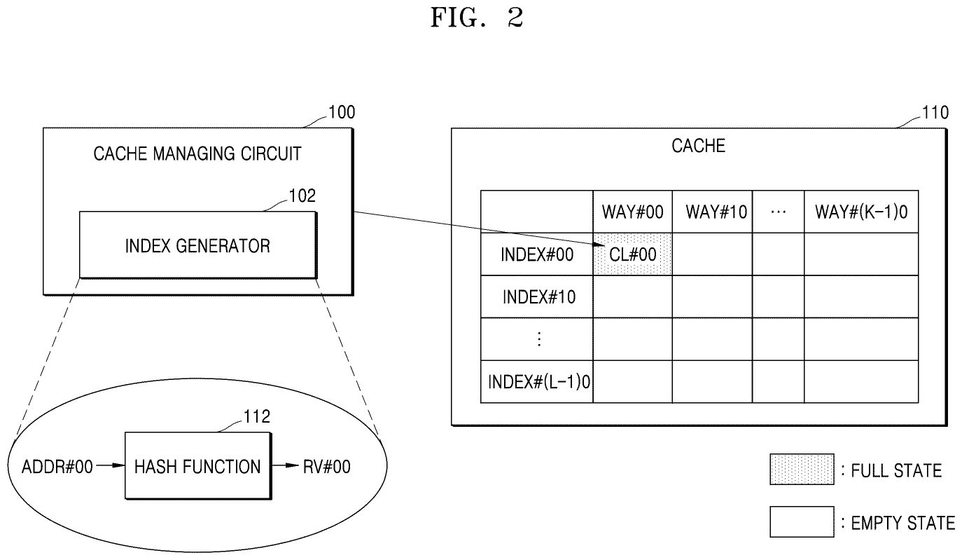

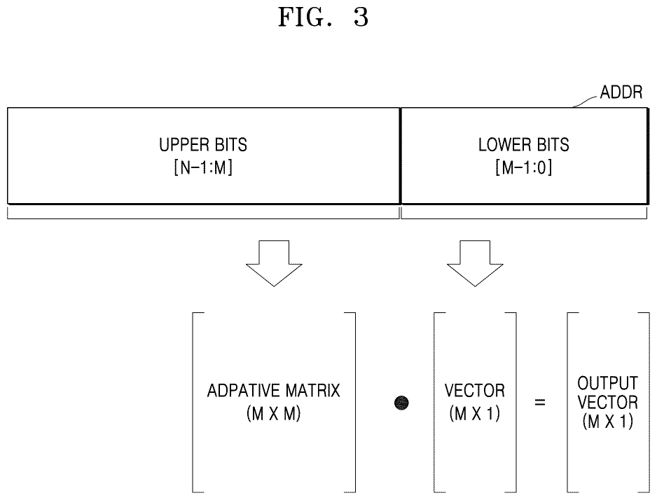

FIG. 2 is a diagram illustrating an operation of a cache managing circuit 100 according to an embodiment.

Referring to FIG. 2, the cache managing circuit 100 may include an index generator (e.g., index generation circuit) 102. According to an embodiment, the index generator 102 may input an address corresponding to data to a hash function 112 and provide a result value output from the hash function 112 according to the input address as an index to the cache managing circuit 100. For example, the index generator 102 may input a first address ADDR #00 corresponding to first data to the hash function 112 and provide a first result value RV #00 output from the hash function 112 according to the first address ADDR #00 as an index to the cache managing circuit 100. The first result value RV #00 may correspond to a first index INDEX #00 among first to L−1 indices INDEX #00 to INDEX #(L−1)0 (where L is an integer of 1 or greater).

According to an embodiment, the hash function 112 is a function which has a nonlinear property between an input of the hash function 112 and an output of the hash function 112. The hash function 112 may include a function that defines a method of generating and calculating an adaptive matrix and a vector.

According to an embodiment, the cache managing circuit 100 may store a first cache line CL #00 including the first data in a region indicated by the first index INDEX #00 from among a plurality of regions of a first way WAY #00 having the highest priority from among first to K−1 ways WAY #00 to WAY #(K−1)0 (where K is an integer of 1 or greater).

FIG. 3 is a diagram illustrating an operation method according to an embodiment, and for example, may be performed by the index generator 102.

Referring to FIG. 3, an address ADDR may include upper bits and lower bits. The address ADDR may include N bits (where N is an integer greater than M), the upper bits may include N−M bits, and the lower bits may include M bits (where M is an integer of 1 or greater). Additionally, the number of lower bits of the address ADDR may correspond to the number of bits of the index. Accordingly, the number of bits of the index may be “M”.

According to an embodiment, the index generator 102 may generate an adaptive matrix having a size of “M×M” based on at least one of the upper bits of the address ADDR and may generate a vector having a size of “M×1” based on the lower bits of the address ADDR. As a specific example, the index generator 102 may generate an adaptive matrix in which at least one of the upper bits of the address ADDR is arranged in a certain pattern. In addition, the index generator 102 may generate an adaptive matrix in which the upper bits of the address ADDR are all (i.e., each of the N−M upper bits) arranged in a certain pattern. For example, the phrase “certain pattern” refers to a pattern included in the adaptive matrix to ensure that the adaptive matrix can have an inverse. An inverse matrix corresponds to the multiplicative inverse of the adaptive matrix. The adaptive matrix must satisfy conditions for the existence of an inverse matrix in order for its inverse to exist. This corresponds to the basic definition of the inverse matrix.

The index generator 102 may perform multiplication and exclusive OR operations between the adaptive matrix and the vector to generate an output vector having a size of “M×1”. As a result, the index generator 102 may identify an index corresponding to the output vector.

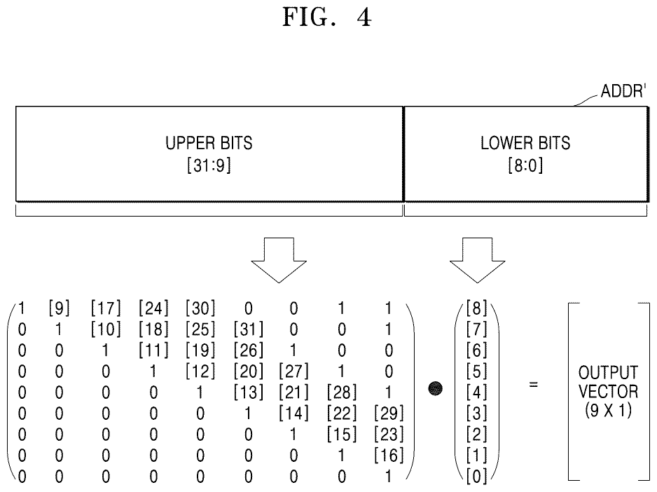

FIG. 4 is a diagram specifically illustrating an operation method according to an embodiment, and for example, may be performed by the index generator 102 in FIG. 2.

Referring to FIG. 4, an address ADDR′ may include upper bits [9] to [31] and lower bits [0] to [8]. The address ADDR′ may include 32 bits, wherein the upper bits [9] to [31] may include 23 bits and the lower bits [0] to [8] may include 9 bits. The number of bits of the index may be 9, which corresponds to the number of lower bits [0] to [8].

According to an embodiment, the index generator 102 may generate an adaptive matrix in which the upper bits [9] to [31] of the address ADDR′ are arranged in a certain pattern. As a specific example, the index generator 102 may generate the adaptive matrix in which the upper bits [9] to [31] are arranged in a certain pattern in elements above a main diagonal in an upper triangular matrix. The index generator 102 may generate a vector based on the lower bits [0] to [8] of the address ADDR′.

The index generator 102 may perform multiplication and exclusive OR operations between the adaptive matrix and the vector to generate an output vector having a size of “9×1”. As a result, the index generator 102 may identify an index corresponding to the output vector.

However, the example of generating the adaptive matrix in FIG. 4 is only an example and embodiments are not limited thereto. The upper bits [9] to [31] may be arranged in the adaptive matrix in various patterns.

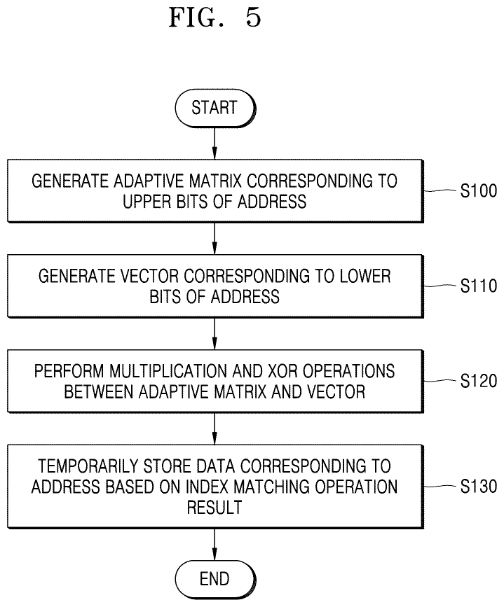

FIG. 5 is a flowchart of an operation method of a host device, according to an embodiment. The operation method of the host device in FIG. 5 may correspond to an operation method of a processor included in the host device or a cache managing circuit included in the processor.

Referring to FIG. 5, in operation S100, the host device may generate an adaptive matrix corresponding to upper bits of the address. According to an embodiment, the host device may generate the adaptive matrix based on the upper bits of the address. As a specific example, in the adaptive matrix generated by the host device, at least one of the upper bits of the address may be arranged in a certain pattern.

In operation S110, the host device may generate a vector corresponding to lower bits of the address.

In operation S120, the host device may perform multiplication and exclusive OR operations between the adaptive matrix generated in operation S100 and the vector generated in operation S110.

In operation S130, the host device may temporarily store data corresponding to the address in a cache based on an index matching the operation result in operation S120. As a specific example, the host device may temporarily store the data in an empty region among regions corresponding to the index in a plurality of ways of the cache. As an example, the data may be stored in the corresponding region of the cache in a form included in a cache line.

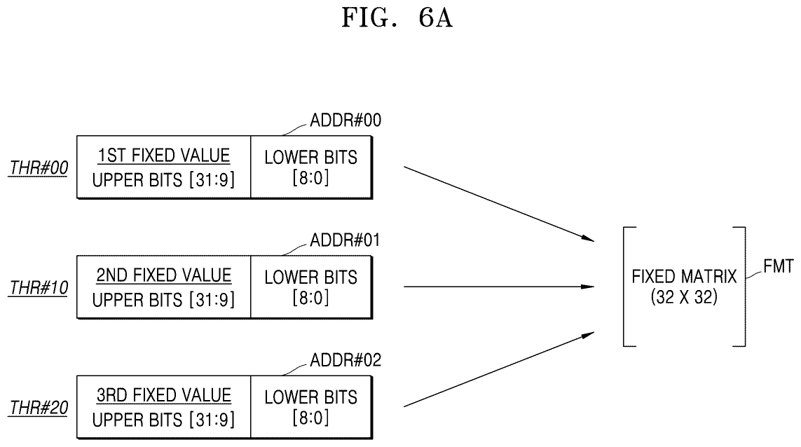

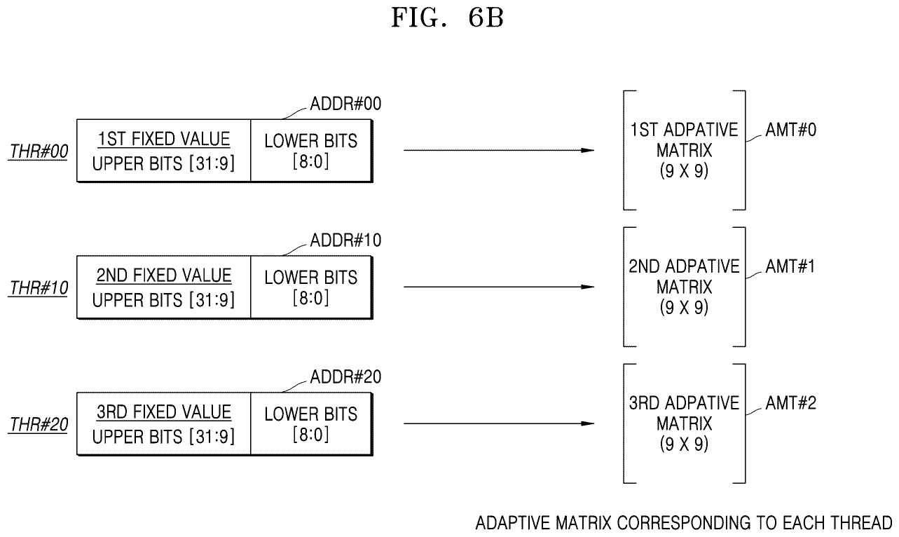

FIG. 6A is a diagram illustrating a fixed matrix FMT in an environment where a process is performed by first to third threads THR #00, THR #10, and THR #20, according to a comparative example, and FIG. 6B is a diagram illustrating first to third adaptive matrices AMT #0, AMT #1, and AMT #2 in an environment where the process is performed by the first to third threads THR #00, THR #10, and THR #20, according to an embodiment. In FIGS. 6A and 6B, it is assumed that the number of upper bits of the address are 23 and the number of lower bits of the address are 9. However, this is merely an example. Embodiments are not limited thereto.

Referring to FIG. 6A, in a comparative example, a first address ADDR #00 corresponding to a first thread THR #00 may include upper bits having a first fixed value and lower bits having an arbitrary value, a second address ADDR #10 corresponding to a second thread THR #10 may include upper bits having a second fixed value and lower bits having an arbitrary value, and a third address ADDR #20 corresponding to a third thread THR #20 may include upper bits having a third fixed value and lower bits having an arbitrary value. The first to third fixed values may be different from each other. That is, the first fixed value may correspond to a unique first value corresponding to the first thread THR #00, the second fixed value may correspond a unique second value corresponding to the second thread THR #10, and the third fixed value may correspond a unique third value corresponding to the third thread THR #20.

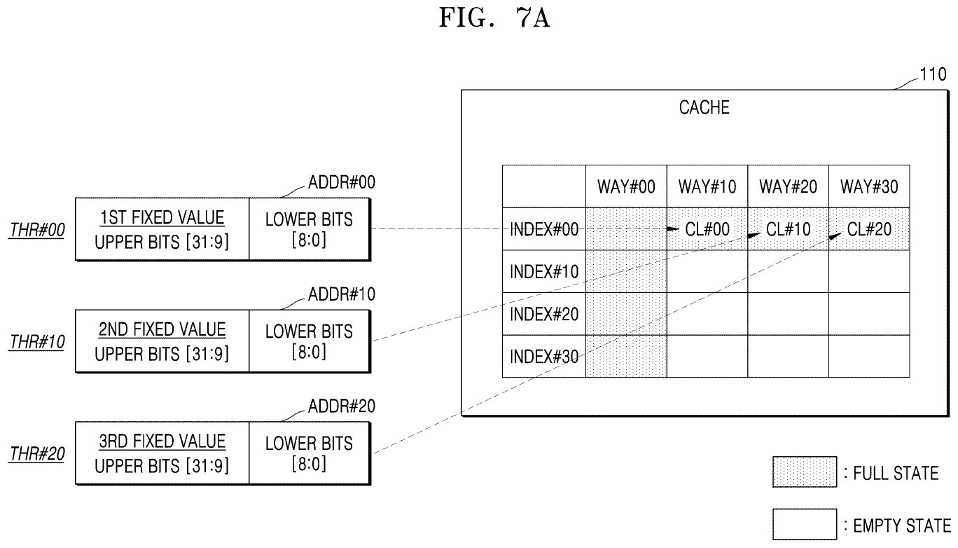

According to a comparative example, the fixed matrix FMT having a size of “32×32” may be used to generate indices corresponding to the first to third addresses ADDR #00, ADDR #10, and ADDR #20. Accordingly, in a comparative example, because the indices are determined in a relatively linear method based on the lower bits of the address ADDR #00, ADDR #10, and ADDR #20, specific indices may be intensively used. A specific example thereof is described below with reference to FIG. 7A.

Referring further to FIG. 6B, in an embodiment, a first adaptive matrix AMT #0 having a size of “9×9” may be used to generate an index corresponding to the first address ADDR #00, a second adaptive matrix AMT #1 having a size of “9×9” may be used to generate an index corresponding to the second address ADDR #10, and a third adaptive matrix AMT #2 having a size of “9×9” may be used to generate an index corresponding to the third address ADDR #20.

According to an embodiment, the first adaptive matrix AMT #0 may be based on the upper bits of the first address ADDR #00 having the first fixed value, the second adaptive matrix AMT #1 may be based on the upper bits of the second address ADDR #10 having the second fixed value, and the third adaptive matrix AMT #2 may be based on the upper bits of the third address ADDR #20 having the third fixed value. The first to third adaptive matrices AMT #0, AMT #1, and AMT #2 corresponding to the first to third threads THR #00, THR #10, and THR #20 may be different from each other.

FIG. 7A is a diagram illustrating an operation of a cache managing circuit in FIG. 6A and FIG. 7B is a diagram illustrating an operation of a cache managing circuit in FIG. 6B. In FIGS. 7A and 7B, it is assumed that the first to third addresses ADDR #00, ADDR #10, and ADDR #20 are sequentially received by the cache managing circuit.

Referring to FIG. 7A, in a comparative example, the cache managing circuit may generate the first index INDEX #00 by using a first vector based on the fixed matrix FMT and the lower bits of the first address ADDR #00. Because the region of the first way WAY #00 among regions corresponding to the first index INDEX #00 is filled, the cache managing circuit may temporarily store a first cache line CL #00 including the first data in an empty region of the next way of the index, second way WAY #10. The cache managing circuit may generate the first index INDEX #00 by using a second vector based on the fixed matrix FMT and the lower bits of the second address ADDR #10. Because the regions of the first and second ways WAY #00 and WAY #10 among regions corresponding to the first index INDEX #00 are filled, the cache managing circuit may temporarily store the second cache line CL #10 including the second data in an empty region of the next way of the index, third way WAY #20. In addition, the cache managing circuit may generate the first index INDEX #00 by using a third vector based on the fixed matrix FMT and the lower bits of the third address ADDR #20. Because the regions of the first to third ways WAY #00, WAY #10, and WAY #20 among the regions corresponding to the first index INDEX #00 are filled, the cache managing circuit may temporarily store the third cache line CL #20 including the third data in an empty region of the next way of the index, fourth way WAY #30.

In a comparative example, because a linear method is used to generate an index, the first index INDEX #00 may be intensively used, which may reduce a utilization rate of some regions of the cache 110. As a result, in a comparative example, the utilization efficiency for the cache 110 may be reduced.

Referring to FIG. 7B, the cache managing circuit may generate the first index INDEX #00 by using the first adaptive matrix AMT #0 based on the upper bits of the first address ADDR #00 and the first vector based on the lower bits of the first address ADDR #00. Because the region of the first way WAY #00 among regions corresponding to the first index INDEX #00 is filled, the cache managing circuit may temporarily store the first cache line CL #00 including the first data in an empty region of the next way of the index, second way WAY #10. The cache managing circuit may generate the second index INDEX #10 by using the second adaptive matrix AMT #1 based on the upper bits of the second address and the second vector based on the lower bits of the first address ADDR #10. Because a region of the first way WAY #00 among regions corresponding to the second index INDEX #10 is filled, the cache managing circuit may temporarily store the second cache line CL #10 including the second data in an empty region of the next way of the index, second way WAY #10. In addition, the cache managing circuit may generate the third index INDEX #20 by using the third adaptive matrix AMT #2 based on the upper bits of the third address and the third vector based on the lower bits of the third address ADDR #20. Because a region of the first way WAY #00 among regions corresponding to the third index INDEX #20 is filled, the cache managing circuit may temporarily store the third cache line CL #20 including the third data in an empty region of the next way of the index, second way WAY #10.

In an embodiment, because a nonlinear method is used to generate an index, the first to fourth indices INDEX #00 to INDEX #30 may be evenly used, thereby increasing the utilization efficiency of the cache 110. As a result, the operating performance of the host device using the cache 110 may be improved. For example, the cache index and the index generated by the index generator are identical.

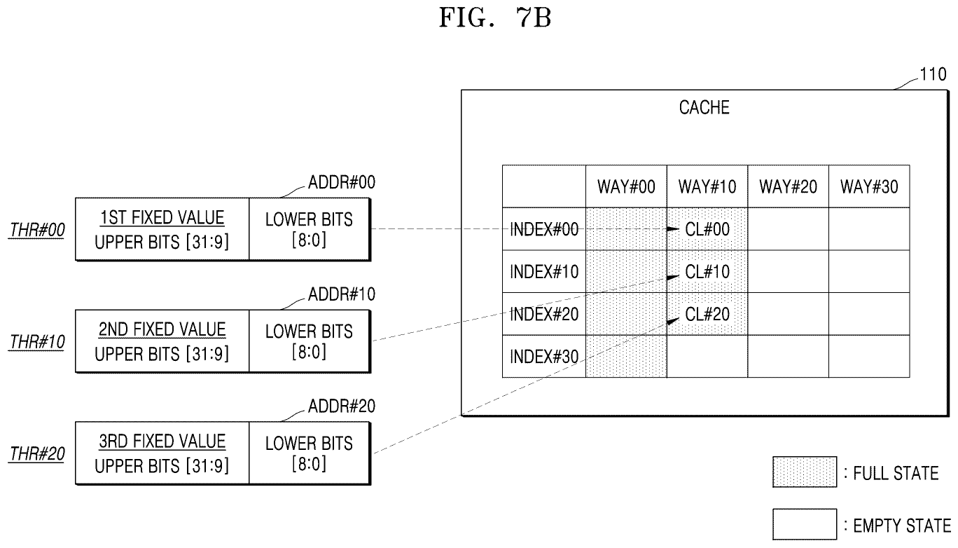

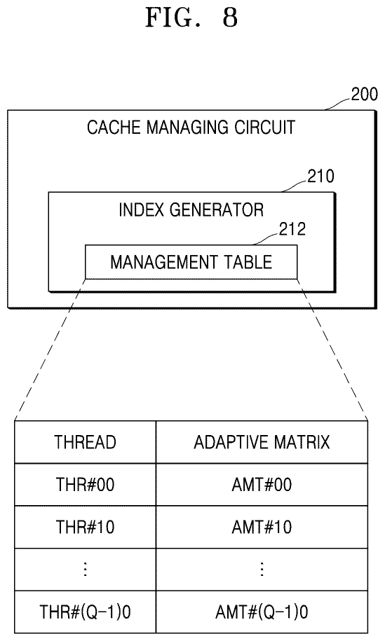

FIG. 8 is a diagram illustrating an operation of a cache managing circuit 200 according to an embodiment.

Referring to FIG. 8, the cache managing circuit 200 may include an index generator (e.g., index generation circuit) 210. The index generator 210 may generate an index of a cache corresponding to an address by referring to a management table 212.

According to an embodiment, the management table 212 may indicate a plurality of adaptive matrices AMT #00 to AMT #(Q−1)0 that are respectively mapped to a plurality of threads THR #00 to THR #(Q−1)0 (where Q is an integer of 2 or greater). As a specific example, the first adaptive matrix AMT #00 may be mapped to the first thread THR #00, the second adaptive matrix AMT #10 may be mapped to the second thread THR #10, and the Q^{th} adaptive matrix AMT_ #(Q−1)0 may be mapped to Q^{th} thread THR #(Q−1)0. In addition, the plurality of adaptive matrices AMT #00 to AMT #(Q−1)0 may be different from each other. In some embodiments, some of the plurality of adaptive matrices AMT #00 to AMT #(Q−1)0 may be the same. This is because, to improve the utilization efficiency of the cache, it is not necessary for all adaptive matrices AMT #00 to AMT #(Q−1)0 to be different.

According to an embodiment, the cache managing circuit 200 may identify a thread corresponding to the received address, refer to the management table 212 based on the identified thread, and identify an adaptive matrix mapped to the identified thread. The cache managing circuit 200 may generate an index corresponding to the received address by using the identified adaptive matrix.

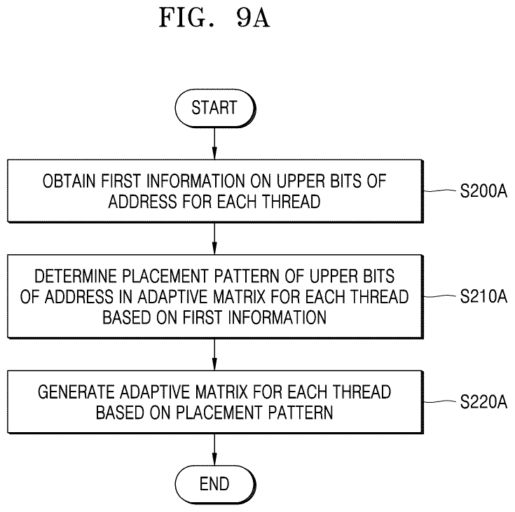

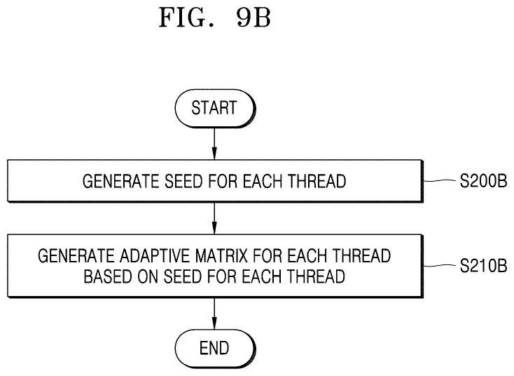

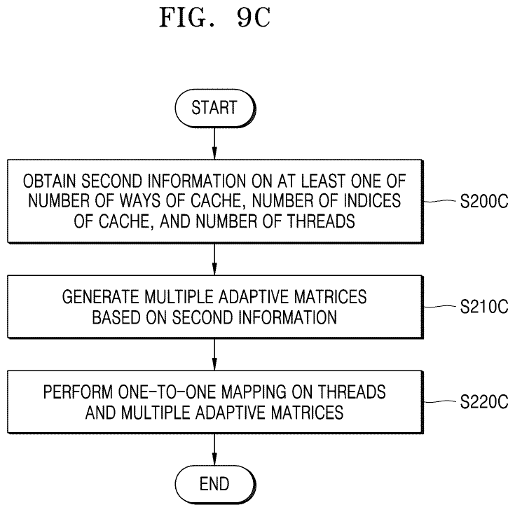

FIGS. 9A to 9C are flowcharts of a method of generating an adaptive matrix, according to an embodiment. An operation of the host device, to be described below, may be understood as an operation of a processor included in the host device or a cache managing circuit included in the processor.

Referring to FIG. 9A, in operation S200A, the host device may obtain first information on upper bits of an address for each thread. The fixed value of the upper bits of the address may be different for each thread and the first information may include the upper bits of the address for each thread.

In operation S210A, the host device may determine a placement pattern of the upper bits of the address in the adaptive matrix for each thread based on the first information obtained in operation S200A.

In operation S220A, the host device may generate the adaptive matrix for each thread based on the placement pattern determined in operation S210A.

The host device may manage the adaptive matrix for each thread by using a table, such as the management table 212 in FIG. 8.

Referring to FIG. 9B, in operation S200B, the host device may generate a seed for each thread. As an example, the host device may generate a first seed corresponding to a first thread and generate a second seed corresponding to a second thread, wherein the first seed and the second seed have different values.

In operation S210B, the host device may generate the adaptive matrix for each thread based on the seed for each thread. As an example, the host device may generate a first adaptive matrix corresponding to the first thread based on a first method or first reference bits corresponding to the first seed. In addition, the host device may generate a second adaptive matrix corresponding to the second thread based on a second method or second reference bits corresponding to the second seed.

The host device may manage the adaptive matrix for each thread by using a table, such as the management table 212 in FIG. 8.

With further reference to FIG. 9C, in operation S200C, the host device may obtain second information on at least one of the number of ways of the cache, the number of indices of the cache, and the number of threads.

In operation S210C, the host device may generate a plurality of adaptive matrices based on the second information obtained in operation S200C. As an example, the host device may generate the plurality of adaptive matrices based on at least one of the number of ways of the cache, the number of indices of the cache, and the number of threads, thereby maximizing utilization efficiency for the cache. In some embodiments, the host device may obtain the plurality of adaptive matrices from a neural network model by inputting the second information into a neural network model trained to generate optimal adaptive matrices.

In operation S220C, the host device may perform one-to-one mapping on the threads and the plurality of adaptive matrices generated in operation S210C.

The host device may manage the adaptive matrix for each thread by using a table, such as the management table 212 in FIG. 8.

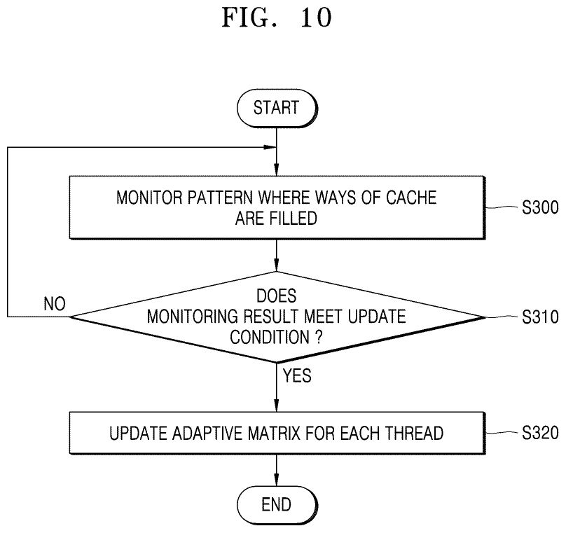

FIG. 10 is a flowchart of a method of updating an adaptive matrix according to an embodiment. The operation of the host device, to be described below, may be understood as the operation of the processor included in the host device or the cache managing circuit included in the processor.

Referring to FIG. 10, in operation S300, the host device may monitor a pattern in which ways of the cache are filled. As an example, the host device may monitor the pattern formed by filled or empty regions among the regions of the ways of the cache.

In operation S310, the host device may determine whether the monitoring result of operation S300 meets the update condition. As an example, the host device may confirm a utilization rate for the cache based on the monitored pattern, wherein the utilization rate falling below a threshold may be set to meet the update condition.

When operation S310 is NO (i.e., when the monitoring result of operation S300 meets the update condition), operation S320 may be followed, so that the host device updates the adaptive matrix for each thread. That is, the host device may newly generate the adaptive matrices corresponding to threads or adjust the placement of components of existing adaptive matrices.

When operation S310 is NO (i.e., when the monitoring result of operation S300 does not meet the update condition), operation S300 may be repeated. In this regard, operation S300 may be repeated until the monitoring result meets the update condition.

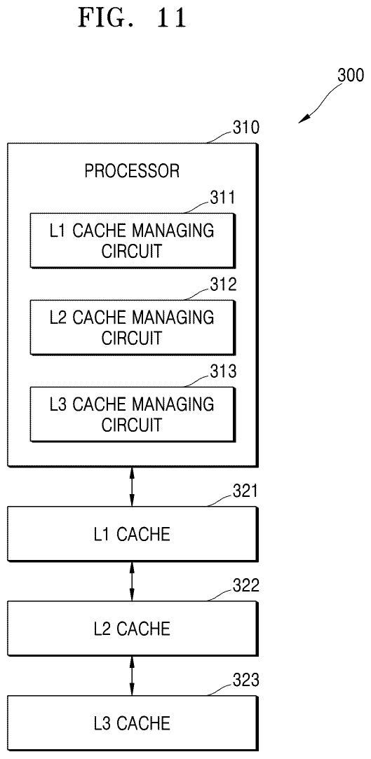

FIG. 11 is a diagram of a host device 300 according to an embodiment.

Referring to FIG. 11, the host device 300 may include a processor 310, an L1 cache 321, an L2 cache 322, and an L3 cache 323.

As an example, the L1 cache 321, the L2 cache 322, and the L3 cache 323 may be hierarchically connected to each other. The L1 cache 321 may cache data frequently used by the processor 310 from among data stored in the L2 cache 322. The L2 cache 322 may cache data frequently used by the processor 310 from among data stored in the L3 cache 323. In addition, the L3 cache 323 may cache data frequently used by the processor 310 from among data stored in the system memory (30 in FIG. 1).

According to an embodiment, the processor 310 may include an L1 cache managing circuit 311, an L2 cache managing circuit 312 and an L3 cache managing circuit 313. The L1 cache managing circuit 311 may generate an index matching the structure of the L1 cache 321 in a manner consistent with embodiments described above. The L2 cache managing circuit 312 may generate an index matching the structure of the L2 cache 322 in a manner according to the embodiments described above. Further, the L3 cache managing circuit 313 may generate an index matching the structure of the L3 cache 323 in a manner according to the embodiments described above.

However, the structure of the host device 300 in FIG. 11 is only an example and embodiments are not limited thereto. Embodiments may be applied to various implementations of the host device 200.

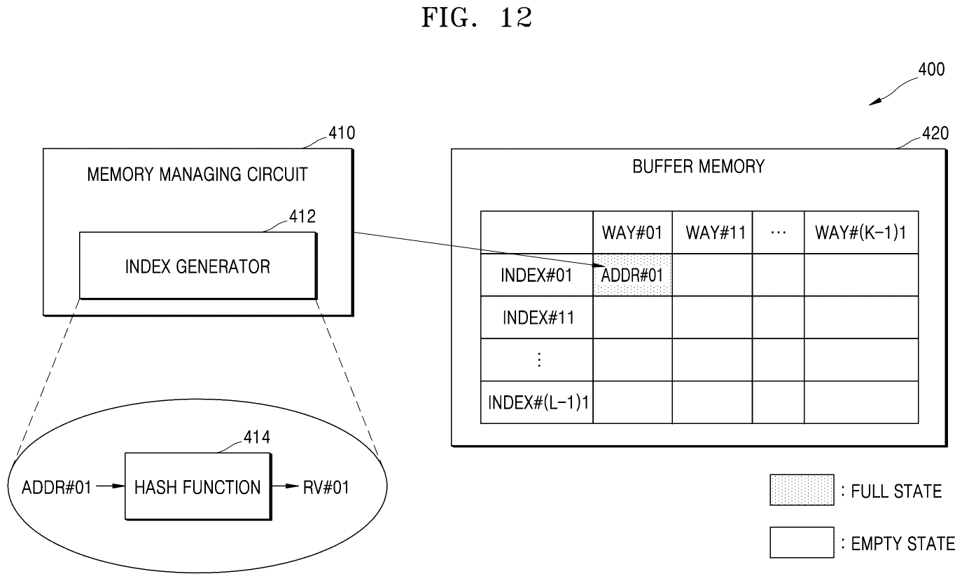

FIG. 12 is a diagram illustrating an operation of a storage device 400 according to an embodiment.

Referring to FIG. 12, the storage device 400 may include a memory managing circuit 410 and buffer memory 420. The memory managing circuit 410 may include an index generator (i.e., index generation circuit) 412.

According to an embodiment, the index generator 412 may input a first address ADDR #01 received with a memory command to a hash function 414 and may provide a first result value RV #01 output from the hash function 414 to the memory managing circuit 410 as an index. The first result value RV #01 may correspond to a first index INDEX #01 from among first to (L−1)^{th} indices INDEX #01 to INDEX #(L−1)1.

According to an embodiment, the hash function 414 is a function which has a nonlinear property between an input of the hash function 414 and an output of the hash function 414. The hash function 414 may include a function that defines a method of generating and calculating an adaptive matrix and a vector.

According to an embodiment, the memory managing circuit 410 may store the first address ADDR #01 in a region indicated by the first index INDEX #01 among a plurality of regions of a first way WAY #01 having the highest priority among first to (K−1)^{th} ways WAY #01 to WAY #(K−1)1.

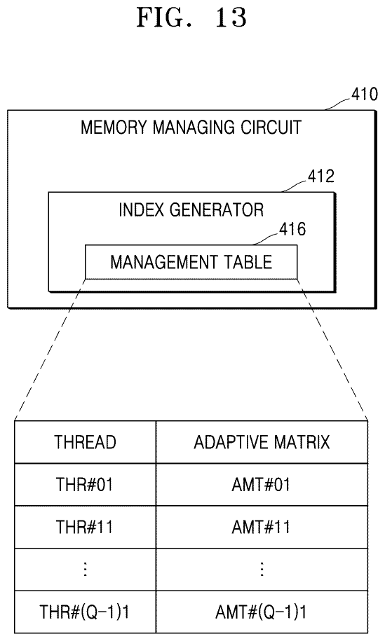

FIG. 13 is a diagram illustrating an operation of a memory managing circuit 410 according to an embodiment.

Referring to FIG. 13, the memory managing circuit 410 may include an index generator 412. The index generator 412 may generate an index of a buffer memory corresponding to an address by referring to a management table 416.

According to an embodiment, the management table 416 may indicate a plurality of adaptive matrices AMT #01 to AMT #(Q−1)1 mapped to a plurality of threads THR #01 to THR #(Q−1)1, respectively. As a specific example, the first adaptive matrix AMT #01 may be mapped to the first thread THR #01, the second adaptive matrix AMT #11 may be mapped to the second thread THR #11, and the Q^{th} adaptive matrix AMT #(Q−1)1 may be mapped to an Q^{th} thread THR #(Q−1)1. In addition, the plurality of adaptive matrices AMT #01 to AMT #(Q−1)1 may be different from each other. In some embodiments, some of the plurality of adaptive matrices AMT #01 to AMT #(Q−1)1 may be the same.

According to an embodiment, the memory managing circuit 410 may identify a thread corresponding to the received address, refer to the management table 416 based on the identified thread, and identify an adaptive matrix mapped to the identified thread. The memory managing circuit 410 may generate an index corresponding to the received address by using the identified adaptive matrix.

Additionally, as described above, embodiments of generating an index of the cache managing circuit may be applied to the method of generating the index of the memory managing circuit 410.

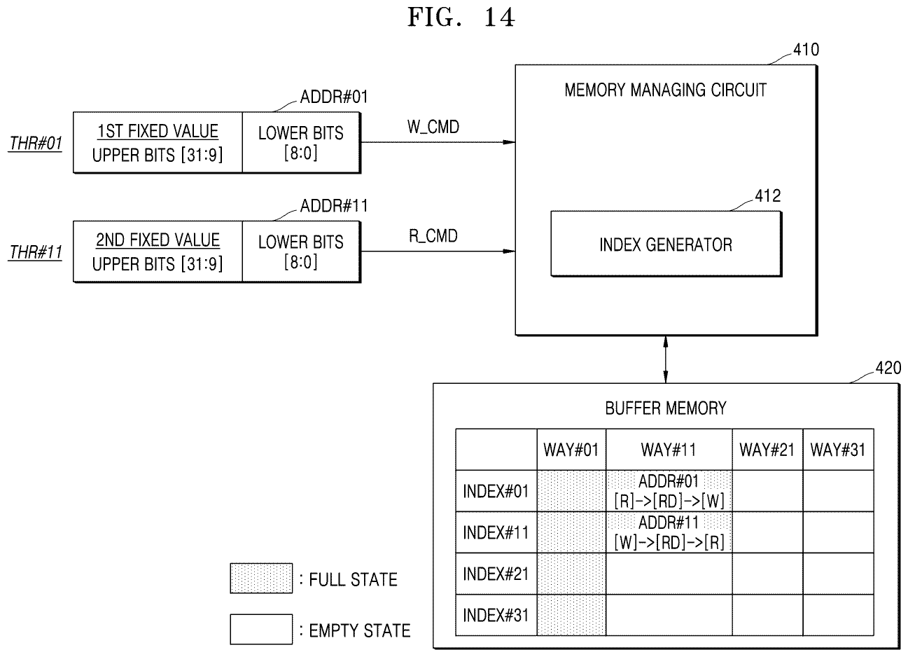

FIG. 14 is a diagram illustrating an operation of a memory managing circuit 410 in an environment in which a process is performed by first and second threads THR #01 and THR #11, according to an embodiment.

Referring to FIG. 14, the memory managing circuit 410 may generate a first index INDEX #01 by using a first adaptive matrix based on upper bits of a first address ADDR #01 corresponding to the first thread THR #01 and a first vector based on lower bits of the first address ADDR #01, and may identify a region of the second way WAY #11 where the first address ADDR #01 is stored based on the first index INDEX #01. The memory managing circuit 410 may confirm status information R indicating that a read operation is being performed on the memory region of the memory device corresponding to the first address ADDR #01 in the region and may defer initiation of a write operation according to a write command W_CMD. Thereafter, the memory managing circuit 410 may initiate the write operation after confirming status information RD indicating that the read operation is completed and is in a ready state, and may modify status information W to indicate that the write operation according to the write command W_CMD is being performed.

In addition, the memory managing circuit 410 may generate the second index INDEX #11 by using a second adaptive matrix based on upper bits of the second address ADDR #11 corresponding to the second thread THR #11 and a second vector based on lower bits of the first address ADDR #11, and may identify a region of the second way WAY #11 in which the second address ADDR #11 is stored based on the second index INDEX #11. The memory managing circuit 410 may confirm the status information W indicating that the write operation is being performed on the memory region of the memory device corresponding to the second address ADDR #11 in the corresponding region and may defer initiation of the read operation according to the read command R_CMD. Thereafter, the memory managing circuit 410 may initiate the read operation after confirming the status information RD indicating that the write operation is completed and is in a ready state, and may modify the status information R to indicate that the read operation according to the read command R_CMD is being performed.

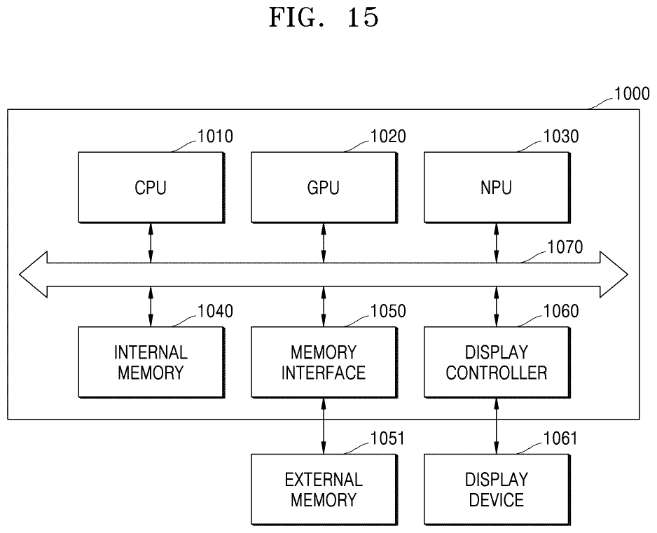

FIG. 15 is a block diagram of a system on chip 1000 according to an embodiment.

Referring to FIG. 15, the system on chip 1000 may include a central processing unit (CPU) 1010, a graphics processing unit (GPU) 1020, a neural network processing unit (NPU) 1030, internal memory 1040, a memory interface 1050, a display controller 1060, and a bus interface 1070. The internal components of the system on chip 1000 may communicate through the bus interface 1070.

According to an embodiment, the CPU 1010 may include a cache managing circuit consistent with embodiments described above. Through the cache managing circuit, data stored in the internal memory 1040 or the external memory (1051) may be efficiently cached in a cache of the CPU 1010 and the cached data may be processed or executed.

According to an embodiment, the GPU 1020 may include a cache managing circuit consistent with embodiments described above. Through the cache managing circuit, data stored in the internal memory 1040 or the external memory 1051 may be efficiently cached in a cache of the GPU 1020, simultaneous matrix operations may be performed on the cached data for deep learning, or the cached data may be converted into a signal suitable for the display device 1061.

According to an embodiment, the NPU 1030 may include a cache managing circuit consistent with embodiments described above. Through the cache management circuit, data stored in the internal memory 1040 or the external memory 1051 may be efficiently cached in a cache of the NPU 1030 and large-scale operations on the cached data may be performed using a neural network.

The display device 1061 may display an image signal output from the display controller 1060. For example, the display device 1061 may be implemented as a liquid crystal display (LCD), a light emitting diode (LED) display, an organic LED (OLED) display, active-matrix OLED (AMOLED) display, or a flexible display. The display controller 1060 may control the operation of the display device 1061.

The internal memory 1040 may include random-access memory (RAM) that temporarily stores programs (or applications), data, or commands.

The memory interface 1050 may communicate with the external memory 1051 via interface. The memory interface 1050 may control the overall operation of the external memory 1051 and may control data exchange between the external memory 1051 and any one of the CPU 1010, the GPU 1020, and the NPU 1030.

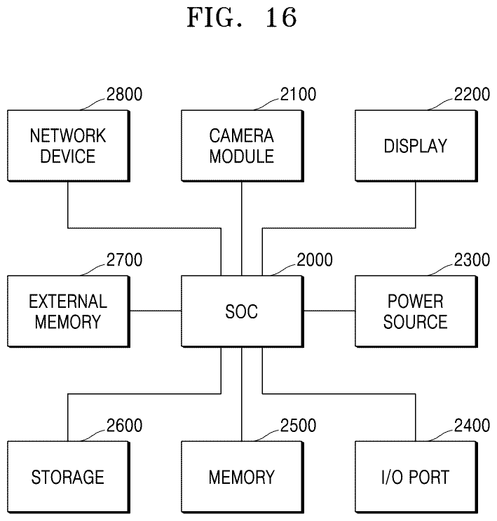

FIG. 16 is a block diagram of an electronic device according to an embodiment.

Referring to FIG. 16, the electronic device may include a system on chip 2000, a camera module 2100, a display 2200, a power source 2300, an input/output (I/O) port 2400, memory 2500, storage 2600, external memory 2700, and a network device 2800.

According to an embodiment, to increase utilization efficiency of a cache of a processor included in the system on chip 2000, the system on chip 2000 may generate an adaptive matrix based on upper bits of an address and may generate an index for using a cache according to a nonlinear method using the generated adaptive matrix.

The camera module 2100 refers to a module capable of converting an optical image into an electrical image. Thus, the electrical image output from the camera module may be stored in the storage 2600, the memory 2500, or the external memory 2700. In addition, the electrical image output from the camera module may be displayed through the display 2200.

The display 2200 may display data output from the storage 2600, the memory 2500, the I/O port 2400, the external memory 2700, or the network device 2800.

The power source 2300 may supply an operating voltage to at least one of the components.

The I/O port 2400 refers to a port configured to transmit data to the electronic device or transmit data output from the electronic device to an external device. For example, the I/O port 2400 may include a port for connecting to a pointing device, such as a computer mouse, a port for connecting to a printer, or a port for connecting to a USB drive.

The memory 2500 may be implemented as volatile memory or non-volatile memory. Depending on embodiments, a memory interface configured to control a data access operation, e.g., read operation, write operation (or program operation), or erase operation, for the memory 2500 may be integrated or built into the system on chip 2000. According to another embodiment, the memory interface may be implemented between the system on chip 2000 and the memory 2500.

The storage 2600 may be implemented as a hard disk drive or a solid state drive (SSD).

The external memory 2700 may be implemented as a secure digital (SD) card or a multimedia card (MMC). Depending on embodiments, the external memory 2700 may include a subscriber identification module (SIM) card or a universal subscriber identity module (USIM) card.

The network device 2800 refers to a device configured to connect the electronic device to a wired network or a wireless network.

The memory managing circuit may be further configured to defer initiation of the first memory operation, based on the state of the region indicating that the first address is previously stored in the region and that a second memory operation for the first address is being performed by the memory device.

While aspects of embodiments have been particularly shown and described, it will be understood that various changes in form and details may be made therein without departing from the spirit and scope of the following claims.

What is claimed is:

1. A host device comprising:
a cache configured to temporarily store a plurality of data copied from a main memory; and
a processor configured to process the plurality of data read from the cache,
wherein the cache comprises a plurality of ways, wherein each of the plurality of ways has regions distinguished by a plurality of indices, the plurality of data comprise first data, and the plurality of indices comprise a first index, and
wherein the processor comprises a cache managing circuit configured to:
generate the first index by using a first adaptive matrix and a first vector, wherein the first adaptive matrix is based on upper bits of a first address corresponding to the first data, and the first vector is based on lower bits of the first address; and
manage the first data to be temporarily stored in an empty region, among regions corresponding to the first index, in the plurality of ways.

2. The host device of claim 1, wherein, in the first adaptive matrix, at least one bit of the upper bits of the first address is arranged in a certain pattern.

3. The host device of claim 1, wherein, in the first adaptive matrix, the upper bits of the first address are arranged in a certain pattern.

4. The host device of claim 1, wherein an inverse matrix to the first adaptive matrix is present.

5. The host device of claim 1, wherein the first adaptive matrix comprises an upper triangular matrix in which the upper bits of the first address are arranged in a certain pattern in elements above a main diagonal of the upper triangular matrix.

6. The host device of claim 1, wherein the cache managing circuit is further configured to determine the first adaptive matrix by using a first method corresponding to the upper bits of the first address.

7. The host device of claim 1, wherein the cache managing circuit is further configured to identify the first adaptive matrix mapped to the upper bits of the first address based on a management table.

8. The host device of claim 1, wherein the cache managing circuit is further configured to generate the first index by performing multiplication and exclusive OR operations on the first adaptive matrix and the first vector.

9. The host device of claim 1, wherein a number of lower bits of the first address matches a number of bits of the first index.

10. The host device of claim 1, wherein the plurality of data further comprise second data, the plurality of indices further comprise a second index, and
wherein the cache managing circuit is further configured to:
generate the second index by using a second adaptive matrix and a second vector, wherein the second adaptive matrix is based on upper bits of a second address corresponding to the second data, and the second vector is based on lower bits of the second address; and
manage the second data to be temporarily stored in an empty region, among regions corresponding to the second index, in the plurality of ways.

11. The host device of claim 10, wherein the first adaptive matrix is different from the second adaptive matrix, based on a value of the upper bits of the first address being different from a value of lower bits of the second address.

12. The host device of claim 10, wherein the first adaptive matrix is identical to the second adaptive matrix, based on values of the upper bits of the first address corresponding to values of the lower bits of the second address.

13. A host device comprising:
a cache configured to temporarily store a plurality of data copied from main memory; and
a processor configured to process the plurality of data read from the cache,
wherein the cache comprises a plurality of ways, wherein each of the plurality of ways has regions distinguished by a plurality of indices, the plurality of data comprise first data, and the plurality of indices comprise a first index, and
wherein the processor comprises a cache managing circuit configured to:
generate the first index by performing a hash operation on a first address corresponding to the first data by using a first adaptive matrix based on a first thread corresponding to the first data; and
manage the first data to be temporarily stored in an empty region, among regions corresponding to the first index, in the plurality of ways.

14. The host device of claim 13, wherein the plurality of data further comprise second data, the plurality of indices further comprise a second index, and
wherein the cache managing circuit is further configured to:
generate the second index by performing a hash operation on a second address corresponding to the second data by using a second adaptive matrix based on a second thread corresponding to the second data; and
manage the second data to be temporarily stored in an empty region among regions corresponding to the second index in the plurality of ways.

15. The host device of claim 14, wherein the first adaptive matrix is different from the second adaptive matrix, based on the first thread and the second thread being different from each other.

16. The host device of claim 14, wherein the first adaptive matrix is identical to the second adaptive matrix, based on the first thread corresponding to the second thread.

17. The host device of claim 13, wherein the cache managing circuit is further configured to identify the first adaptive matrix mapped to the first thread from a management table indicating a plurality of adaptive matrices mapped to a plurality of threads, respectively.

18. The host device of claim 17, wherein the cache managing circuit is further configured to monitor a pattern in which the plurality of ways are to be filled and, update the management table based a result of the monitoring.

19. The host device of claim 13, wherein the host device comprises any one of a central processing unit (CPU), a graphics processing unit (GPU), and a neural network processing unit (NPU).

20. A method of operating a host device including a cache, wherein the cache includes a plurality of ways, wherein each of the plurality of ways has regions distinguished by a plurality of indices, the method comprising:
generating an adaptive matrix, based on upper bits of an address corresponding to data;
generating a vector, based on lower bits of the address;
performing a hash operation, based on the adaptive matrix and the vector; and
storing the data in an empty region, among regions corresponding to an index generated from the hash operation, in the plurality of ways.
